(19) United States
(12) Patent Application Publication
(10) Pub. No.: US 2025/0261009 A1
(43) Pub. Date: Aug. 14, 2025

(54) MEASUREMENT METHOD AND APPARATUS, COMMUNICATION DEVICE, AND STORAGE MEDIUM

(71) Applicant: Beijing Xiaomi Mobile Software Co., Ltd., Beijing (CN)

(72) Inventor: Xuhua TAO, Beijing (CN)

(73) Assignee: Beijing Xiaomi Mobile Software Co., Ltd., Beijing (CN)

(21) Appl. No.: 18/849,356

(22) PCT Filed: Mar. 21, 2022
(86) PCT No.: PCT/CN2022/082090

§ 371 Date: Sep. 20, 2024

(51) Int. Cl. H04W 24/08; H04W 36/36; H04W 76/27

(52) U.S. Cl. CPC H04W 24/08; H04W 36/362; H04W 76/27

(57) ABSTRACT

A measurement method, performed by a base station, including: sending indication information to a terminal, where the indication information is configured to determine a preferred measurement object for a mobility measurement to be performed by the terminal before leaving a serving cell, and a type of the preferred measurement object includes at least one of a carrier or a cell.

### CROSS-REFERENCE TO RELATED APPLICATION

The present application is a U.S. National Stage of International Application No. PCT/CN2022/082090, filed on Mar. 21, 2022, all of the contents of which are incorporated herein by reference in their entireties for all purposes.

### BACKGROUND OF THE INVENTION

Some new characteristics are introduced to a non-terrestrial networks (NTN) system, for example, a cell with a super large coverage, the cell is mobile, and other characteristics.

### SUMMARY OF THE INVENTION

The disclosure relates to, but is not limited to, the field of wireless communications, in particular to a measurement method and apparatus, a communication device, and a storage medium.

According to a first aspect of the disclosure, there is provided a measurement method. The measurement method is performed by a base station. The measurement method includes: sending indication information to a terminal; where the indication information is configured to determine a preferred measurement object for a mobility measurement to be performed by the terminal before leaving a serving cell; where a type of the preferred measurement object includes at least one of a carrier or a cell.

According to a second aspect of the disclosure, there is provided a measurement method. The measurement method is performed by a terminal. The measurement method includes: receiving indication information; where the indication information is configured to determine a preferred measurement object for a mobility measurement to be performed by the terminal before leaving a serving cell; where a type of the preferred measurement object includes at least one of a carrier or a cell.

According to a third aspect of the disclosure, there is provided a measurement apparatus, including: a sending module, configured to send indication information to a terminal; where the indication information is configured to determine a preferred measurement object for a mobility measurement to be performed by the terminal before leaving a serving cell; where a type of the preferred measurement object includes at least one of a carrier or a cell.

According to a fourth aspect of the disclosure, there is provided a measurement apparatus, including: a receiving module, configured to receive indication information; where the indication information is configured to determine a preferred measurement object for a mobility measurement to be performed by a terminal before leaving a serving cell; where a type of the preferred measurement object includes at least one of a carrier or a cell.

According to a fifth aspect of the disclosure, there is provided a communication device, including: a processor; and a memory, configured to store an executable instruction executable by the processor. Where the processor is configured to implement, when running the executable instruction, the method in any example of the disclosure.

According to a sixth aspect of the disclosure, there is provided a non-transitory computer-readable storage medium, storing a computer-executable program, where the computer-executable program, when executed by a processor, implements the method in any example of the disclosure.

### BRIEF DESCRIPTION OF DRAWINGS

The drawings here are incorporated in the description as a constituent part of the description, illustrate examples conforming to the disclosure, and serve to explain principles of the disclosure along with the description.

FIG. 1 is a schematic structural diagram of a wireless communication system according to an example.

FIG. 2 is a schematic diagram of an NTN communication according to an example.

FIG. 3 is a schematic flowchart of a measurement method according to an example.

FIG. 4 is a schematic flowchart of a measurement method according to an example.

FIG. 5 is a schematic flowchart of a measurement method according to an example.

FIG. 6 is a schematic flowchart of a measurement method according to an example.

FIG. 7 is a schematic flowchart of a measurement method according to an example.

FIG. 8 is a schematic flowchart of a measurement method according to an example.

FIG. 9 is a schematic flowchart of a measurement method according to an example.

FIG. 10 is a schematic flowchart of a measurement method according to an example.

FIG. 11 is a schematic flowchart of a measurement method according to an example.

FIG. 12 is a schematic flowchart of a measurement method according to an example.

FIG. 13 is a schematic flowchart of a measurement method according to an example.

FIG. 14 is a schematic structural diagram of a measurement apparatus according to an example.

FIG. 15 is a schematic structural diagram of a measurement apparatus according to an example.

FIG. 16 is a schematic structural diagram of a terminal according to an example.

FIG. 17 is a block diagram of a base station according to an example.

FIG. 18 is a block diagram of a communication device according to an example.

### DETAILED DESCRIPTION OF THE INVENTION

Examples will be described in detail, and their instances are represented in the accompanying drawings. Unless otherwise indicated, when the following description refers to the accompanying drawings, the same number in the different accompanying drawings represents the same or similar elements. Implementations described in the following examples do not represent all implementations consistent with the examples of the disclosure. Rather, they are examples of an apparatus and method consistent with some aspects of the examples of the disclosure as detailed in appended claims.

Terms used in the examples of the disclosure are intended to describe specific examples but not to limit the examples of the disclosure. A singular form “a/an” and “said” used in the examples and the appended claims of the disclosure is also intended to include a plural form unless other meanings are indicated clearly in the context. It is to be further understood that a term “and/or” used in the disclosure refers to and contains any one or all possible combinations of one or a plurality of associated listed items.

It is to be understood that various pieces of information, possibly described by using terms such as first, second and third in the examples of the disclosure, are not limited to these terms. These terms are used to distinguish the same type of information. For example, without departing from the scope of the examples of the disclosure, first information may also be called second information, and similarly, the second information may also be called the first information. Depending on the context, words such as “if” and “in a case that” used in the disclosure may be construed as “when . . . ”, or “while . . . ” or “in response to determining”.

For being concise and convenient understanding, a size relationship, when represented in the disclosure, is described by a term “greater than” or “less than”. However, those skilled in the art may understand that the term “greater than” also covers a meaning of “greater than or equal to”, and “less than” also covers a meaning of “less than or equal to”.

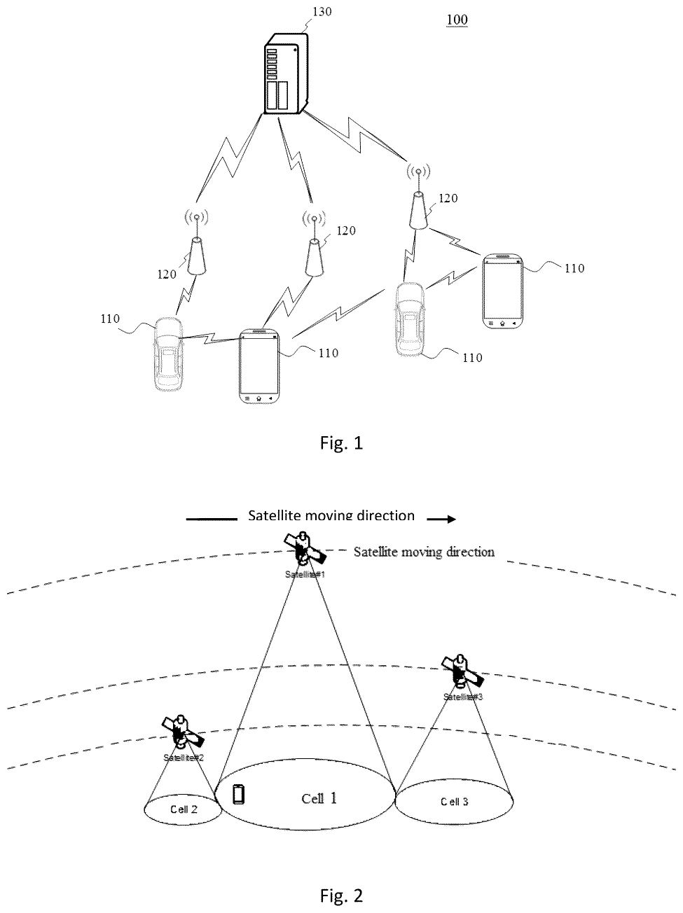

Please refer to FIG. 1, which shows a schematic structural diagram of a wireless communication system according to an example of the disclosure. As shown in FIG. 1, the wireless communication system 100 is a communication system based on a mobile communication technology. The wireless communication system 100 may include a plurality of user equipment (UE) 110 and a plurality of base stations 120.

The user equipment 110 may refer to a device providing speech and/or data connectivity for a user. The user equipment 110 may communicate with one or more core networks via a radio access network (RAN). The user equipment 110 may be Internet of Things user equipment, for example, a sensor device, a mobile phone and a computer with the Internet of Things user equipment, for example, may be a fixed, portable, pocket, hand-held, built-in-computer or vehicle-mounted apparatus. For example, the user equipment 110 may be a station (STA), a subscriber unit, a subscriber station, a mobile station, a mobile, a remote station, an access point, a remote terminal, an access terminal, a user terminal, a user agent, a user device, or user equipment. Alternatively, the user equipment 110 may be a device of an unmanned aerial vehicle. Alternatively, the user equipment 110 may be a vehicle-mounted device, for example, may be a trip computer with a wireless communication function, or a wireless user device externally connected with the trip computer. Alternatively, the user equipment 110 may be a road-side unit, for example, may be a street lamp, a signal lamp, or other road-side units with a wireless communication function.

The base station 120 may be a network device in the wireless communication system. The wireless communication system may be a 4^{th} generation mobile communication (4G) system, or is also called long term evolution (LTE) system. Alternatively, the wireless communication system may also be a 5G system, or is also called a new radio system or a 5G NR system. Alternatively, the wireless communication system may also be a next generation system of the 5G system. An access network in the 5G system may be called a new generation-radio access network (NG-RAN).

The base station 120 may be an evolved base station (eNB) adopted in the 4G system. Alternatively, the base station 120 may also be gNB adopting a centralized-distributed architecture in the 5G system. The base station 120, when adopting the centralized-distributed architecture, generally includes a central unit (CU) and at least two distributed units (DUs). A protocol stack of a packet data convergence protocol (PDCP) layer, a radio link control (RLC) layer and a media access control (MAC) layer is arranged in the central unit. A protocol stack of a physical (PHY) layer is arranged in each distributed unit. A specific implementation of the base station 120 is not limited by the example of the disclosure.

A wireless connection may be established between the base station 120 and the user equipment 110 through a wireless radio. In different implementations, the wireless radio may be a wireless radio based on a 4^{th} generation mobile communication network technology (4G) standard. Alternatively, the wireless radio may be a wireless radio based on a 5^{th} generation mobile communication network technology (5G) standard, for example, the wireless radio may be a new radio. Alternatively, the wireless radio may also be a wireless radio based on a next generation mobile communication network technology standard of the 5G.

In some examples, an end to end (E2E) connection may also be established between the user equipment 110, for example, a vehicle to vehicle (V2V) communication, a vehicle to Infrastructure (V2I) communication and a vehicle to pedestrian (V2P) communication and other scenes in vehicle to everything (V2X).

The user equipment may be regarded as a terminal in the following examples.

In some examples, the wireless communication system 100 may further include a network management device 130.

The plurality of base stations 120 are connected with the network management device 130 respectively. The network management device 130 may be a core network device in the wireless communication system. For example, the network management device 130 may be a mobility management entity (MME) in an evolved packet core (EPC). Alternatively, the network management device 130 may also be another core network device, for example, a serving gateway (SGW), a public data network gateway (PGW), a policy and charging rules function (PCRF) and a home subscriber server (HSS). The implementation form of the network management device 130 is not limited in the example of the disclosure.

For making those skilled in the art understand conveniently, the examples of the disclosure list a plurality of implementations so as to clearly describe the technical solutions of the examples of the disclosure. Those skilled in the art may understand that a plurality of examples provided by the examples of the disclosure may be performed independently or performed in combination with methods in the other examples of the disclosure, or may also be performed independently or in combination together with some methods in the other related art, which is not limited by the examples of the disclosure.

Some new characteristics are introduced to a non-terrestrial networks (NTN) system, for example, a cell with a super large coverage, the cell is mobile, and other characteristics. A measurement solution in related art cannot be performed or accurately performed due to these characteristics.

In the NTN system, network deployment of the cell may be mobile, a terminal may stay in a serving cell for a short time, and the terminal possibly cannot complete a related measurement due to the short time, which may prevent the terminal from implementing normal wireless communication.

For better understanding the technical solution described in any example of the disclosure, an application scene is described firstly.

In an example, please refer to FIG. 2, a terminal stays in a Cell 1 for time T1 and then will enter a Cell 2. Before entering the Cell 2, the terminal needs to complete a configured mobility measurement. In a case that there are too many configured to-be-measured carriers, the terminal possibly cannot complete the measurement on these configured carriers within the time T1, so it is necessary to study how to perform the measurement by the terminal in this case.

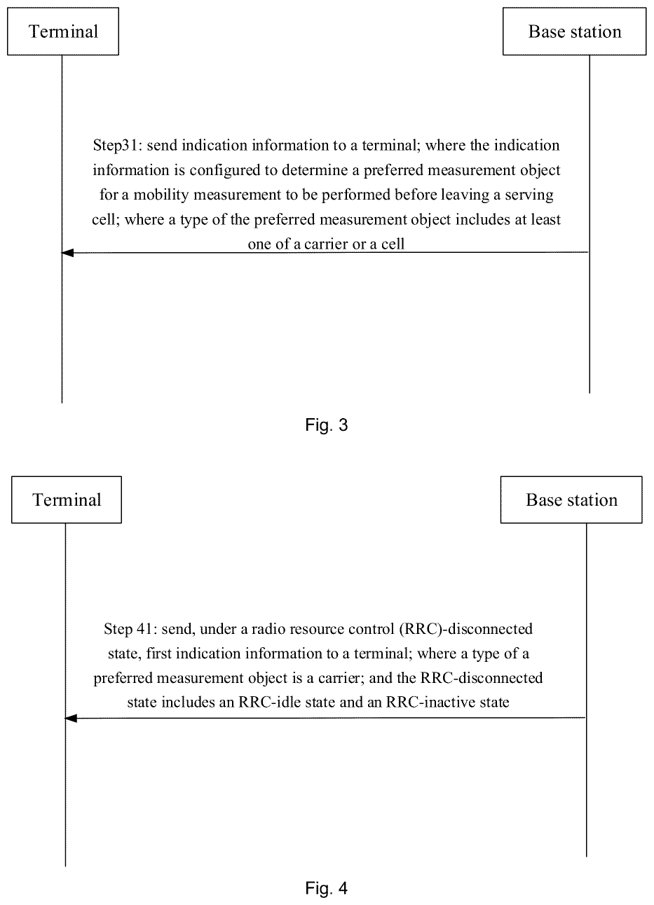

As shown in FIG. 3, there is provided a measurement method. The measurement method is performed by a base station. The measurement method includes step 31.

Step 31 includes sending indication information to a terminal. The indication information is configured to determine a preferred measurement object for a mobility measurement to be performed by the terminal before leaving a serving cell. A type of the preferred measurement object includes at least one of a carrier or a cell.

The terminal involved in the disclosure may be, but is not limited to, a mobile phone, a wearable device, a vehicle-mounted terminal, a road side unit (RSU), a smart home terminal, an industrial sensor device and/or a medical device, and the like. In some examples, the terminal may be a Redcap terminal or a new radio (NR) terminal of a predetermined version (for example, an NR terminal of Release 17 (R17)).

The base station involved in the disclosure may be an access device of a terminal access network. The base station may be base stations of various types, for example, a base station of a third generation mobile communication (3G) network, a base station of a fourth generation mobile communication (4G) network, a base station of a fifth generation mobile communication (5G) network, or another evolved base station.

The type of the preferred measurement object includes at least one of a carrier or a cell. The preferred measurement object is an object measured preferentially when performing the mobility measurement, for example, at least one of a carrier 1 or a cell 1 measured preferentially when performing the mobility measurement.

It is to be noted that the method may be applied to an NTN system.

In an example, the indication information is sent to the terminal through a system message (for example, a system information block (SIB)) in response to the terminal being in a radio resource control (RRC)-disconnected state. The indication information is configured to determine the preferred measurement object for the mobility measurement to be performed by the terminal before leaving the serving cell. The type of the preferred measurement object includes a carrier. The carrier may be a plurality of carriers contained in a same carrier set. The RRC-disconnected state includes an RRC-idle state and an RRC-inactive state.

In an example, it is determined, in response to the terminal being in the RRC-disconnected state, whether a measurement on all pre-configured carriers can be completed by the terminal before leaving the serving cell. The indication information is sent to the terminal in response to determining that the measurement on all the pre-configured carriers cannot be completed. The indication information is configured to determine the preferred measurement object for the mobility measurement to be performed by the terminal before leaving the serving cell. The type of the preferred measurement object includes a carrier. The carrier may be a plurality of carriers contained in a same carrier set.

In an example, it is determined, in response to the terminal being in the RRC-disconnected state, whether a measurement on all pre-configured carriers can be completed by the terminal within a period from a time when the terminal starts performing a neighbor cell-measurement to a time when the serving cell stops providing a service. The indication information is sent to the terminal in response to determining that the measurement on all the pre-configured carriers cannot be completed. The indication information is configured to determine the preferred measurement object for the mobility measurement to be performed by the terminal before leaving the serving cell. The type of the preferred measurement object includes a carrier. The carrier may be a plurality of carriers contained in a same carrier set.

In an example, configuration information is sent to the terminal, where the configuration information is configured to indicate a pre-configured carrier. It is determined, in response to the terminal being in the RRC-disconnected state, whether a measurement on all pre-configured carriers can be completed by the terminal within a period from a time when the terminal starts performing a neighbor cell-measurement to a time when the serving cell stops providing a service. The indication information is sent to the terminal in response to determining that the measurement on all the pre-configured carriers cannot be completed. The indication information is configured to determine the preferred measurement object for the mobility measurement to be performed by the terminal before leaving the serving cell. The type of the preferred measurement object includes a carrier. The carrier may be a plurality of carriers contained in a same carrier set.

In an example, the indication information is sent to the terminal through an RRC message in response to the terminal being in an RRC-connected state. The indication information is configured to determine the preferred measurement object for the mobility measurement to be performed by the terminal before leaving the serving cell. The type of the preferred measurement object includes a cell. The cell may be a plurality of cells contained in a same cell set.

In an example, it is determined, in response to the terminal being in the RRC-connected state, whether a measurement on all pre-configured cells can be completed by the terminal before leaving the serving cell. The indication information is sent to the terminal in response to determining that the measurement on all the pre-configured cells cannot be completed. The indication information is configured to indicate the preferred measurement object for the mobility measurement to be performed by the terminal before leaving the serving cell. The type of the preferred measurement object includes a cell. The cell may be a plurality of cells contained in a same cell set.

In an example, it is determined, in response to the terminal being in the RRC-connected state, whether a measurement on all pre-configured cells can be completed by the terminal within a period from a time when the terminal receives condition handover (CHO) configuration information to a time when the terminal leaves the serving cell. The indication information is sent to the terminal in response to determining that the measurement on all the pre-configured cells cannot be completed. The indication information is configured to determine the preferred measurement object for the mobility measurement to be performed by the terminal before leaving the serving cell. The type of the preferred measurement object includes a cell. The cell may be a plurality of cells contained in a same cell set.

In an example, configuration information (for example, CHO configuration information) is sent to the terminal, where the configuration information is configured to indicate a pre-configured cell. It is determined, in response to the terminal being in the RRC-connected state, whether a measurement on all pre-configured cells can be completed by the terminal within a period from a time when the terminal receives the condition handover (CHO) configuration information to a time when the terminal leaves the serving cell. The indication information is sent to the terminal in response to determining that the measurement on all the pre-configured cells cannot be completed. The indication information is configured to determine the preferred measurement object for the mobility measurement to be performed by the terminal before leaving the serving cell. The type of the preferred measurement object includes a cell. The cell may be a plurality of cells contained in a same cell set.

In an example, the preferred measurement object includes a plurality of carriers, and the carriers have different priority levels. The indication information is sent to the terminal. The indication information is configured to determine at least one of the preferred measurement object for the mobility measurement to be performed by the terminal before leaving the serving cell, or the priority levels of the carriers. In this way, the terminal may perform the mobility measurement based on the priority levels after receiving the indication information.

In an example, the priority level of the carrier may be determined according to quality of carrier transmission data. For example, the priority level of the carrier is determined to be greater than a level threshold in response to the quality of the carrier transmission data being greater than a quality threshold. Alternatively, the priority level of the carrier is determined to be less than the level threshold in response to the quality of the carrier transmission data being less than the quality threshold. In this way, the priority level of the carrier may adapt to the quality of the carrier transmission data.

In an example, the preferred measurement object includes a plurality of cells, and the plurality of cells have different priority levels. The indication information is sent to the terminal. The indication information is configured to determine at least one of the preferred measurement object for the mobility measurement to be performed by the terminal before leaving the serving cell, or priority levels of the cells. In this way, the terminal may perform the mobility measurement based on the priority levels after receiving the indication information.

In an example, the priority levels of the cells may be determined according to signal qualities of the cells. For example, the priority level of the cell is determined to be greater than a level threshold in response to the signal quality of the cell being greater than a quality threshold. Alternatively, the priority level of the cell is determined to be less than the level threshold in response to the signal quality of the cell being less than the quality threshold. In this way, the priority levels of the cells may adapt to the signal qualities of the cells.

It is to be noted that “less than” in the disclosure has a meaning of “less than or equal to” in certain scenes; and “greater than” in the disclosure has a meaning of “greater than or equal to” in certain scenes.

In the examples of the disclosure, the indication information is sent to the terminal. The indication information is configured to determine the preferred measurement object for the mobility measurement to be performed by the terminal before leaving the serving cell. The type of the preferred measurement object includes at least one of a carrier or a cell. The indication information may be used to determine the preferred measurement object for the mobility measurement to be performed by the terminal before leaving the serving cell, so the terminal may preferentially perform the mobility measurement on the preferred measurement object before leaving the serving cell. Compared with a manner for any measurement object, the mobility measurement on the preferred measurement object may be completed preferentially, and thus reliability of the wireless communications may be improved.

In an example, the indication information may explicitly indicate the preferred measurement object, for example, carrying an identity of one or more preferred measurement objects, and the like.

In an example, the indication information may indirectly carry information related to the preferred measurement object, so that the terminal can determine one or more preferred measurement objects based on the indication information.

It is to be noted that those skilled in the art can understand that the method provided by the examples of the disclosure may be performed independently or performed together with some methods in examples of the disclosure or some methods in related art.

As shown in FIG. 4, there is provided a measurement method. The measurement method may be performed by a base station. The measurement method may include step 41.

Step 41 includes sending, under a radio resource control (RRC)-disconnected state, first indication information to the terminal; where the type of the preferred measurement object is a carrier; and the RRC-disconnected state includes an RRC-idle state and an RRC-inactive state.

The first indication information is configured to determine a preferred measurement object for a mobility measurement to be performed by the terminal before leaving a serving cell. The type of the preferred measurement object includes a carrier.

In an example, the first indication information is sent to the terminal through a system message (for example, a system information block (SIB)) in response to the terminal being in the RRC-disconnected state. The first indication information is configured to determine the preferred measurement object for the mobility measurement to be performed by the terminal before leaving the serving cell. The type of the preferred measurement object includes a carrier. The carrier may be a plurality of carriers contained in a same carrier set. The RRC-disconnected state includes an RRC-idle state and an RRC-inactive state.

In an example, it is determined, in response to the terminal being in the RRC-disconnected state, whether a measurement on all pre-configured carriers can be completed by the terminal before leaving the serving cell. The first indication information is sent to the terminal in response to determining that the measurement on all the pre-configured carriers cannot be completed. The first indication information is configured to determine the preferred measurement object for the mobility measurement to be performed by the terminal before leaving the serving cell. The type of the preferred measurement object includes a carrier. The carrier may be a plurality of carriers contained in a same carrier set.

In an example, it is determined, in response to the terminal being in the RRC-disconnected state, whether a measurement on all pre-configured carriers can be completed by the terminal within a period from a time when the terminal starts performing a neighbor cell-measurement to a time when the serving cell stops providing a service. The first indication information is sent to the terminal in response to determining that the measurement on all the pre-configured carriers cannot be completed. The first indication information is configured to determine the preferred measurement object for the mobility measurement to be performed by the terminal before leaving the serving cell. The type of the preferred measurement object includes a carrier. The carrier may be a plurality of carriers contained in a same carrier set.

In an example, configuration information is sent to the terminal, where the configuration information is configured to indicate a pre-configured carrier. It is determined, in response to the terminal being in the RRC-disconnected state, whether a measurement on all pre-configured carriers can be completed by the terminal within a period from a time when the terminal starts performing a neighbor cell-measurement to a time when the serving cell stops providing a service. The first indication information is sent to the terminal in response to determining that the measurement on all the pre-configured carriers cannot be completed. The first indication information is configured to determine the preferred measurement object for the mobility measurement to be performed by the terminal before leaving the serving cell. The type of the preferred measurement object includes a carrier. The carrier may be a plurality of carriers contained in a same carrier set.

It is to be noted that those skilled in the art can understand that the method provided by the examples of the disclosure may be performed independently or performed together with some methods in examples of the disclosure or some methods in related art.

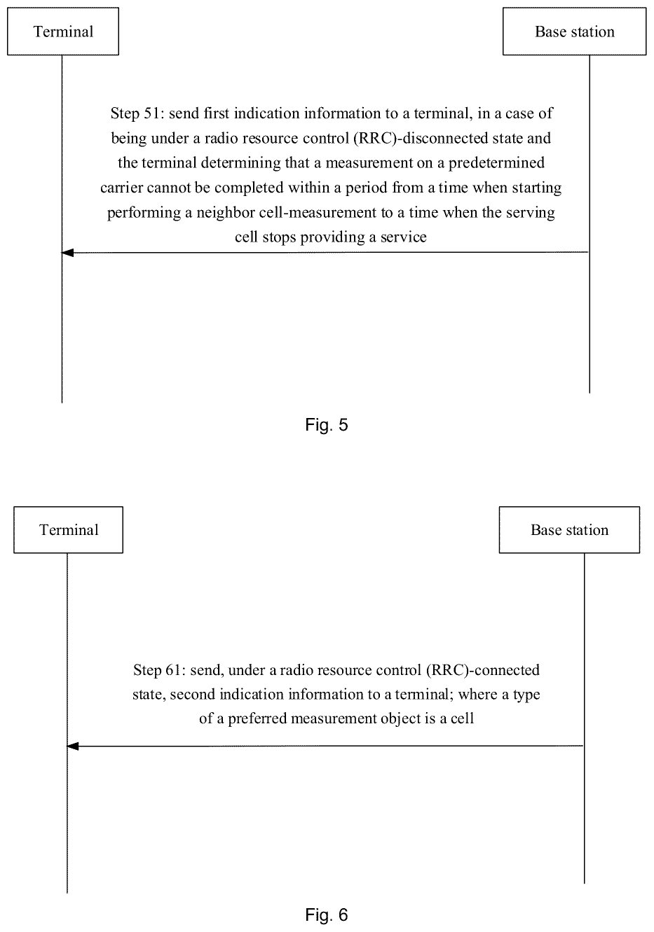

As shown in FIG. 5, there is provided a measurement method. The measurement method may be performed by a base station. The measurement method may include step 51.

Step 51 includes sending the first indication information to the terminal, in a case of being under the RRC-disconnected state and determining that a measurement on a predetermined carrier cannot be completed by the terminal within a period from a time when the terminal starts performing a neighbor cell-measurement to a time when the serving cell stops providing a service.

In an example, configuration information is sent to the terminal, where the configuration information is configured to indicate a pre-configured carrier. It is determined, in response to the terminal being in the RRC-disconnected state, whether a measurement on all pre-configured carriers can be completed by the terminal within a period from a time when the terminal starts performing a neighbor cell-measurement to a time when the serving cell stops providing a service. The first indication information is sent to the terminal in response to determining that the measurement on all the pre-configured carriers cannot be completed. The first indication information is configured to determine the preferred measurement object for the mobility measurement to be performed by the terminal before leaving the serving cell. The type of the preferred measurement object includes a carrier. The carrier may be a plurality of carriers contained in a same carrier set.

In an example, time information about when the serving cell stops the service may be sent to the terminal by a network. The terminal, after receiving the time information, may determine a duration (T) from current time to a time when the serving cell stops the service. The terminal may calculate a duration (T′) needed for completing the mobility measurements according to configuration information for the mobility measurements, and in a case that T′ is greater than T, the terminal may determine that configured mobility measurements cannot be completed. In this case, the terminal may perform the mobility measurements only on the preferred measurement object (including the carrier) according to the indication information.

In an example, report information sent by the terminal may be received by the base station, where the report information indicates that the measurement on the predetermined carrier cannot be completed by the terminal within the period from the time when the terminal starts performing the neighbor cell-measurement to the time when the serving cell stops providing the service. The base station determines based on the report information that the measurement on the predetermined carrier cannot be completed by the terminal within the period from the time when the terminal starts performing the neighbor cell-measurement to the time when the serving cell stops providing the service.

It is to be noted that those skilled in the art can understand that the method provided by the examples of the disclosure may be performed independently or performed together with some methods in examples of the disclosure or some methods in related art.

As shown in FIG. 6, there is provided a measurement method. The measurement method may be performed by a base station. The measurement method may include step 61.

Step 61 includes sending, under a radio resource control (RRC)-connected state, second indication information to the terminal; where the type of the preferred measurement object is a cell.

The second indication information is configured to determine a preferred measurement object for a mobility measurement to be performed by the terminal before leaving a serving cell. The type of the preferred measurement object includes a cell.

In an example, the second indication information is sent to the terminal through an RRC message in response to the terminal being in the RRC-connected state. The second indication information is configured to determine the preferred measurement object for the mobility measurement to be performed by the terminal before leaving the serving cell. The type of the preferred measurement object includes a cell. The cell may be a plurality of cells contained in a same cell set.

In an example, it is determined, in response to the terminal being in the RRC-connected state, whether a measurement on all pre-configured cells can be completed by the terminal before leaving the serving cell. The second indication information is sent to the terminal in response to determining that the measurement on all the pre-configured cells cannot be completed. The second indication information is configured to determine the preferred measurement object for the mobility measurement to be performed by the terminal before leaving the serving cell. The type of the preferred measurement object includes a cell. The cell may be a plurality of cells contained in a same cell set.

In an example, it is determined, in response to the terminal being in the RRC-connected state, whether a measurement on all pre-configured cells can be completed by the terminal within a period from a time when the terminal receives condition handover (CHO) configuration information to a time when the terminal leaves the serving cell. The second indication information is sent to the terminal in response to determining that the measurement on all the pre-configured cells cannot be completed. The second indication information is configured to determine the preferred measurement object for the mobility measurement to be performed by the terminal before leaving the serving cell. The type of the preferred measurement object includes a cell. The cell may be a plurality of cells contained in a same cell set.

In an example, configuration information (for example, CHO configuration information) is sent to the terminal, where the configuration information is configured to indicate a pre-configured cell. It is determined, in response to the terminal being in the RRC-connected state, whether a measurement on all pre-configured cells can be completed by the terminal within a period from a time when the terminal receives the condition handover (CHO) configuration information to a time when the terminal leaves the serving cell. The second indication information is sent to the terminal in response to determining that the measurement on all the pre-configured cells cannot be completed. The second indication information is configured to determine the preferred measurement object for the mobility measurement to be performed by the terminal before leaving the serving cell. The type of the preferred measurement object includes a cell. The cell may be a plurality of cells contained in a same cell set.

It is to be noted that those skilled in the art can understand that the method provided by the example of the disclosure may be performed independently or performed together with some methods in examples of the disclosure or some methods in related art.

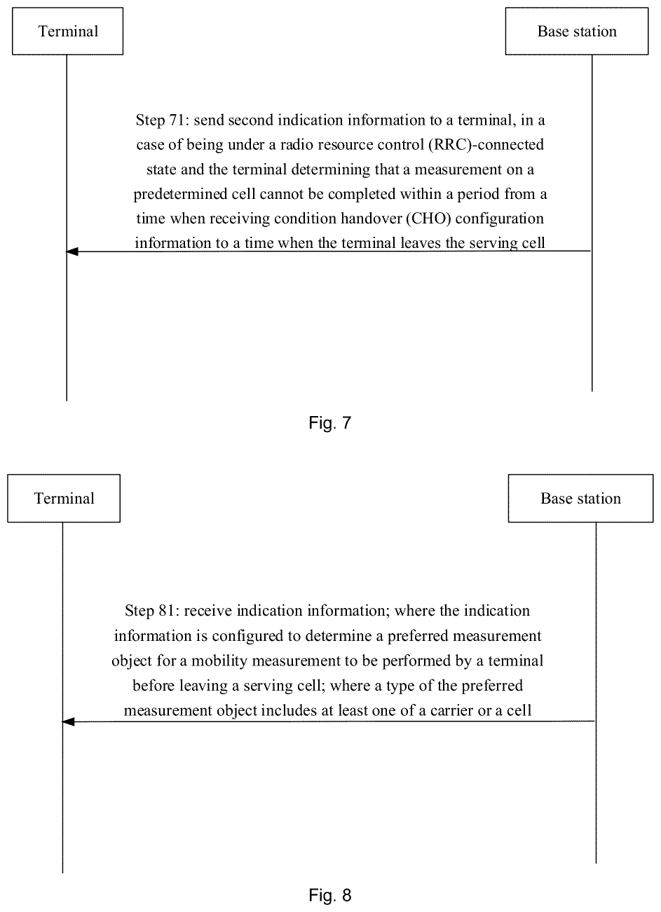

As shown in FIG. 7, there is provided a measurement method. The measurement method may be performed by a base station. The measurement method may include step 71.

Step 71 includes sending the second indication information to the terminal, in a case of being under the RRC-connected state and determining that a measurement on a predetermined cell cannot be completed by the terminal within a period from a time when the terminal receives condition handover (CHO) configuration information to a time when the terminal leaves the serving cell.

In an example, configuration information (for example, CHO configuration information) is sent to the terminal, where the configuration information is configured to indicate a pre-configured cell. It is determined, in response to the terminal being in the RRC-connected state, whether a measurement on all pre-configured cells can be completed by the terminal within a period from a time when the terminal receives the condition handover (CHO) configuration information to a time when the terminal leaves the serving cell. The second indication information is sent to the terminal in response to determining that the measurement on all the pre-configured cells cannot be completed. The second indication information is configured to determine the preferred measurement object for the mobility measurement to be performed by the terminal before leaving the serving cell. The type of the preferred measurement object includes a cell. The cell may be a plurality of cells contained in a same cell set.

In an example, time information about when the serving cell stops the service may be sent to the terminal by a network. The terminal, after receiving the time information, may determine a duration (T) from current time to a time when the serving cell stops the service. The terminal may calculate a duration (T′) needed for completing the mobility measurements according to configuration information for the mobility measurements, and in a case that T′ is greater than T, the terminal may determine that configured mobility measurements cannot be completed. In this case, the terminal may perform the mobility measurements only on the preferred measurement object (including the cell) according to the indication information.

In an example, report information sent by the terminal may be received by the base station, where the report information indicates that the measurement on the predetermined cell cannot be completed by the terminal within the period from the time when the terminal starts performing the neighbor cell-measurement to the time when the serving cell stops providing the service. The base station determines based on the report information that the measurement on the predetermined cell cannot be completed by the terminal within the period from the time when the terminal starts performing the neighbor cell-measurement to the time when the serving cell stops providing the service.

It is to be noted that those skilled in the art can understand that the method provided by the example of the disclosure may be performed independently or performed together with some methods in examples of the disclosure or some methods in related art.

As shown in FIG. 8, there is provided a measurement method. The measurement method may be performed by a terminal. The measurement method may include step 81.

Step 81 includes receiving indication information; where the indication information is configured to determine a preferred measurement object for a mobility measurement to be performed by the terminal before leaving a serving cell; where a type of the preferred measurement object includes at least one of a carrier or a cell.

The terminal involved in the disclosure may be but is not limited to a mobile phone, a wearable device, a vehicle-mounted terminal, a road side unit (RSU), a smart home terminal, an industrial sensor device and/or a medical device, and the like. In some examples, the terminal may be a Redcap terminal or a new radio (NR) terminal of a predetermined version (for example, an NR terminal of R17).

A base station involved in the disclosure may be an access device of a terminal access network. The base station may be base stations of various types, for example, a base station of a third generation mobile communication (3G) network, a base station of a fourth generation mobile communication (4G) network, a base station of a fifth generation mobile communication (5G) network, or another evolved base station.

The type of the preferred measurement object includes at least one of a carrier or a cell. The preferred measurement object is an object measured preferentially when performing the mobility measurement, for example, at least one of a carrier 1 or a cell 1 measured preferentially when performing the mobility measurement.

It is to be noted that the method may be applied to an NTN system.

In an example, the indication information is sent to the terminal by the base station through a system message (for example, a system information block (SIB)) in response to the terminal being in an RRC-disconnected state. The indication information is configured to determine the preferred measurement object for the mobility measurement to be performed by the terminal before leaving the serving cell. The type of the preferred measurement object includes a carrier. The carrier may be a plurality of carriers contained in a same carrier set. The RRC-disconnected state includes an RRC-idle state and an RRC-inactive state. The terminal, after receiving the indication information, performs, before leaving the serving cell, the mobility measurement on a carrier determined based on the indication information.

In an example, it is determined by the base station, in response to the terminal being in the RRC-disconnected state, whether a measurement on all pre-configured carriers can be completed by the terminal before leaving the serving cell. The indication information is sent to the terminal by the base station in response to determining that the measurement on all the pre-configured carriers cannot be completed. The indication information is configured to determine the preferred measurement object for the mobility measurement to be performed by the terminal before leaving the serving cell. The type of the preferred measurement object includes a carrier. The carrier may be a plurality of carriers contained in a same carrier set. The terminal, after receiving the indication information, performs, before leaving the serving cell, the mobility measurement on a carrier determined based on the indication information.

In an example, it is determined by the base station, in response to the terminal being in the RRC-disconnected state, whether a measurement on all pre-configured carriers can be completed by the terminal within a period from a time when the terminal starts performing a neighbor cell-measurement to a time when the serving cell stops providing a service. The indication information is sent to the terminal by the base station in response to determining that the measurement on all the pre-configured carriers cannot be completed. The indication information is configured to determine the preferred measurement object for the mobility measurement to be performed by the terminal before leaving the serving cell. The type of the preferred measurement object includes a carrier. The carrier may be a plurality of carriers contained in a same carrier set. The terminal, after receiving the indication information, performs, before leaving the serving cell, the mobility measurement on a carrier determined based on the indication information.

In an example, configuration information is sent to the terminal by the base station, where the configuration information is configured to indicate a pre-configured carrier. It is determined by the base station, in response to the terminal being in the RRC-disconnected state, whether a measurement on all pre-configured carriers can be completed by the terminal within a period from a time when the terminal starts performing the neighbor cell-measurement to a time when the serving cell stops providing the service. The indication information is sent to the terminal by the base station in response to determining that the measurement on all the pre-configured carriers cannot be completed. The indication information is configured to determine the preferred measurement object for the mobility measurement to be performed by the terminal before leaving the serving cell. The type of the preferred measurement object includes a carrier. The carrier may be a plurality of carriers contained in a same carrier set. The terminal, after receiving the indication information, performs, before leaving the serving cell, the mobility measurement on a carrier determined based on the indication information.

In an example, the indication information is sent to the terminal by the base station through an RRC message in response to the terminal being in an RRC-connected state. The indication information is configured to determine the preferred measurement object for the mobility measurement to be performed by the terminal before leaving the serving cell. The type of the preferred measurement object includes a cell. The cell may be a plurality of cells contained in a same cell set. The terminal, after receiving the indication information, performs, before leaving the serving cell, the mobility measurement on a cell determined based on the indication information.

In an example, it is determined by the base station, in response to the terminal being in the RRC-connected state, whether a measurement on all pre-configured cells can be completed by the terminal before leaving the serving cell. The indication information is sent to the terminal by the base station in response to determining that the measurement on all the pre-configured cells cannot be completed. The indication information is configured to indicate the preferred measurement object for the mobility measurement to be performed by the terminal before leaving the serving cell. The type of the preferred measurement object includes a cell. The cell may be a plurality of cells contained in a same cell set. The terminal, after receiving the indication information, performs, before leaving the serving cell, the mobility measurement on a cell determined based on the indication information.

In an example, it is determined by the base station, in response to the terminal being in the RRC-connected state, whether a measurement on all pre-configured cells can be completed by the terminal within a period from a time when the terminal receives condition handover (CHO) configuration information to a time when the terminal leaves the serving cell. The indication information is sent to the terminal by the base station in response to determining that the measurement on all the pre-configured cells cannot be completed. The indication information is configured to determine the preferred measurement object for the mobility measurement to be performed by the terminal before leaving the serving cell. The type of the preferred measurement object includes a cell. The cell may be a plurality of cells contained in a same cell set. The terminal, after receiving the indication information, performs, before leaving the serving cell, the mobility measurement on a cell determined based on the indication information.

In an example, configuration information (for example, CHO configuration information) is sent to the terminal by the base station, where the configuration information is configured to indicate a pre-configured cell. It is determined by the base station, in response to the terminal being in the RRC-connected state, whether a measurement on all pre-configured cells can be completed by terminal within a period from a time when the terminal receives the condition handover (CHO) configuration information to a time when the terminal leaves the serving cell. The indication information is sent to the terminal by the base station in response to determining that the measurement on all the pre-configured cells cannot be completed. The indication information is configured to determine the preferred measurement object for the mobility measurement to be performed by the terminal before leaving the serving cell. The type of the preferred measurement object includes a cell. The cell may be a plurality of cells contained in a same cell set. The terminal, after receiving the indication information, performs, before leaving the serving cell, the mobility measurement on a cell determined based on the indication information.

In an example, the preferred measurement object includes a plurality of carriers, and the plurality of carriers have different priority levels. The indication information is sent to the terminal by the base station. The indication information is configured to determine at least one of the preferred measurement object for the mobility measurement to be performed by the terminal before leaving the serving cell, or the priority levels of the carriers. In this way, the terminal may perform the mobility measurement based on the priority levels after receiving the indication information.

In an example, the priority levels of the carriers may be determined according to quality of carrier transmission data. For example, the priority level of the carrier is determined to be greater than a level threshold in response to the quality of the carrier transmission data being greater than a quality threshold. Alternatively, the priority level of the carrier is determined to be less than the level threshold in response to the quality of the carrier transmission data being less than the quality threshold. In this way, the priority level of the carrier may adapt to the quality of the carrier transmission data.

In an example, the preferred measurement object includes a plurality of cells, and the plurality of cells have different priority levels. The indication information is sent to the terminal by the base station. The indication information is configured to determine at least one of the preferred measurement object for the mobility measurement to be performed by the terminal before leaving the serving cell, or the priority levels of the cells. In this way, the terminal may perform the mobility measurement based on the priority levels after receiving the indication information.

In an example, the priority levels of the cells may be determined according to signal quality of the cells. For example, the priority level of the cell is determined to be greater than a level threshold in response to the signal quality of the cell being greater than a quality threshold. Alternatively, the priority level of the cell is determined to be less than the level threshold in response to the signal quality of the cell being less than the quality threshold. In this way, the priority levels of the cells may adapt to the signal quality of the cells.

It is to be noted that “less than” in the disclosure has a meaning of “less than or equal to” in certain scene; and “greater than” in the disclosure has a meaning of “greater than or equal to” in certain scene.

It is to be noted that those skilled in the art can understand that the method provided by the example of the disclosure may be performed independently or performed together with some methods in examples of the disclosure or some methods in related art.

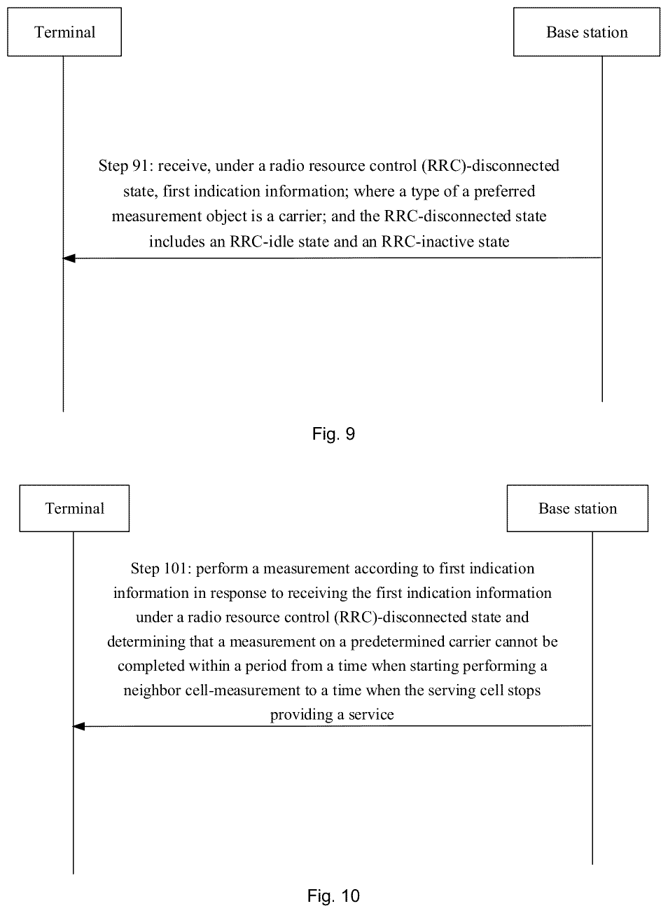

As shown in FIG. 9, there is provided a measurement method. The measurement method may be performed by a terminal. The measurement method may include step 91.

Step 91 includes receiving, under a radio resource control (RRC)-disconnected state, first indication information; where the type of the preferred measurement object is a carrier; and the RRC-disconnected state includes an RRC-idle state and an RRC-inactive state.

The first indication information is configured to determine the preferred measurement object for the mobility measurement to be performed before leaving the serving cell. The type of the preferred measurement object includes a carrier.

In an example, the first indication information is sent to the terminal by the base station through a system message (for example, a system information block (SIB)) in response to the terminal being in the RRC-disconnected state. The first indication information is configured to determine the preferred measurement object for the mobility measurement to be performed by the terminal before leaving the serving cell. The type of the preferred measurement object includes a carrier. The carrier may be a plurality of carriers contained in a same carrier set. The RRC-disconnected state includes the RRC-idle state and the RRC-inactive state. The terminal, after receiving the first indication information, performs, before leaving the serving cell, the mobility measurement on a cell determined based on the first indication information.

In an example, it is determined by the base station, in response to the terminal being in the RRC-disconnected state, whether a measurement on all pre-configured carriers can be completed by the terminal before leaving the serving cell. The first indication information is sent to the terminal by the base station in response to determining that the measurement on all the pre-configured carriers cannot be completed. The first indication information is configured to determine the preferred measurement object for the mobility measurement to be performed by the terminal before leaving the serving cell. The type of the preferred measurement object includes a carrier. The carrier may be a plurality of carriers contained in a same carrier set. The terminal, after receiving the first indication information, performs, before leaving the serving cell the mobility measurement on a cell determined based on the first indication information.

In an example, it is determined by the base station, in response to the terminal being in the RRC-disconnected state, whether a measurement on all pre-configured carriers can be completed by the terminal within a period from a time when the terminal starts performing a neighbor cell-measurement to a time when the serving cell stops providing the service. The first indication information is sent to the terminal by the base station in response to determining that the measurement on all the pre-configured carriers cannot be completed. The first indication information is configured to determine the preferred measurement object for the mobility measurement to be performed by the terminal before leaving the serving cell. The type of the preferred measurement object includes a carrier. The carrier may be a plurality of carriers contained in a same carrier set. The terminal, after receiving the first indication information, performs, before leaving the serving cell, the mobility measurement on a cell determined based on the first indication information.

In an example, configuration information is sent to the terminal by the base station, where the configuration information is configured to indicate a pre-configured carrier. It is determined by the base station, in response to the terminal being in the RRC-disconnected state, whether a measurement on all pre-configured carriers can be completed by the terminal within a period from a time when the terminal starts performing a neighbor cell-measurement to a time when the serving cell stops providing the service. The first indication information is sent to the terminal in response to determining that the measurement on all the pre-configured carriers cannot be completed. The first indication information is configured to determine the preferred measurement object for the mobility measurement to be performed by the terminal before leaving the serving cell. The type of the preferred measurement object includes a carrier. The carrier may be a plurality of carriers contained in a same carrier set. The terminal, after receiving the first indication information, performs, before leaving the serving cell, the mobility measurement on a carrier determined based on the first indication information.

It is to be noted that those skilled in the art can understand that the method provided by the example of the disclosure may be performed independently or performed together with some methods in examples of the disclosure or some methods in related art.

As shown in FIG. 10, there is provided a measurement method. The measurement method may be performed by a terminal. The measurement method may include step 101.

Step 101 includes performing a measurement according to the first indication information, in response to receiving the first indication information under the RRC-disconnected state and determining that a measurement on a predetermined carrier cannot be completed within a period from a time when the terminal starts performing a neighbor cell-measurement to a time when the serving cell stops providing a service.

In an example, configuration information is sent to the terminal by the base station, where the configuration information is configured to indicate a pre-configured carrier. It is determined by the base station, in response to the terminal being in the RRC-disconnected state, whether a measurement on all pre-configured carriers can be completed by the terminal within a period from a time when the terminal starts performing a neighbor cell-measurement to a time when the serving cell stops providing the service. The first indication information is sent to the terminal by the base station in response to determining that the measurement on all the pre-configured carriers cannot be completed. The first indication information is configured to determine the preferred measurement object for the mobility measurement to be performed by the terminal before leaving the serving cell. The type of the preferred measurement object includes a carrier. The carrier may be a plurality of carriers contained in a same carrier set. The terminal may perform the mobility measurement according to the first indication information, in response to receiving the first indication information under the RRC-disconnected state and determining that the measurement on the predetermined carrier cannot be completed within the period from the time when the terminal starts performing the neighbor cell-measurement to the time when the serving cell stops providing the service.

In an example, time information about when the serving cell stops the service may be sent to the terminal by a network. The terminal, after receiving the time information, may determine a duration (T) from current time to a time when the serving cell stops the service. The terminal may calculate a duration (T′) needed for completing the mobility measurements according to configuration information for the mobility measurements, and in a case that T′ is greater than T, the terminal may determine that the measurement on all the pre-configured carriers cannot be completed.

In an example, report information may be sent by the terminal to the base station. The report information indicates that the measurement on the predetermined carrier cannot be completed by the terminal within the period from the time when the terminal starts performing the neighbor cell-measurement to the time when the serving cell stops providing the service. The base station determines based on the report information that the measurement on the predetermined carrier cannot be completed by the terminal within the period from the time when the terminal starts performing the neighbor cell-measurement to the time when the serving cell stops providing the service.

It is to be noted that those skilled in the art can understand that the method provided by the example of the disclosure may be performed independently or performed together with some methods in examples of the disclosure or some methods in related art.

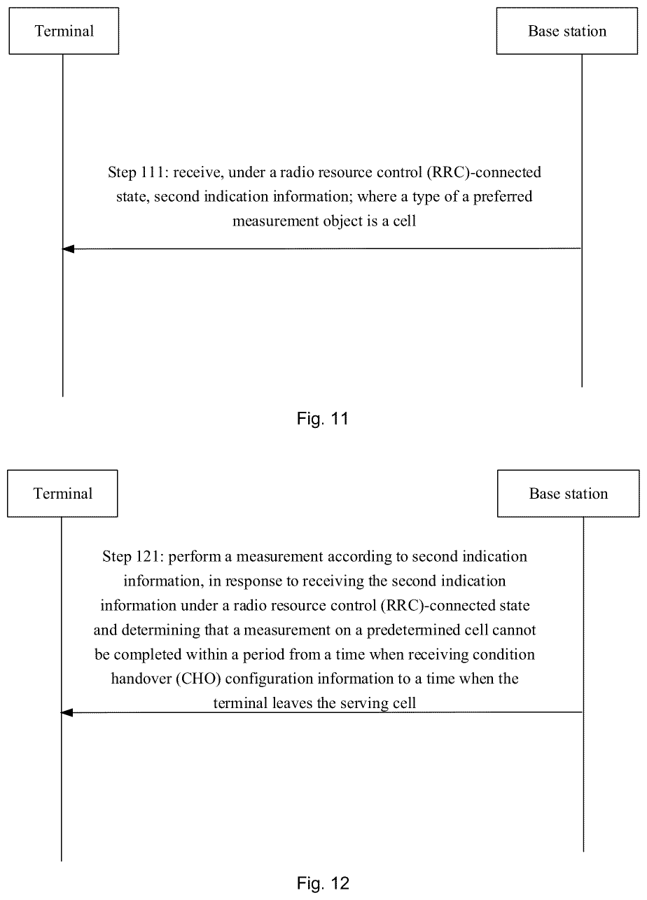

As shown in FIG. 11, there is provided a measurement method. The measurement method may be performed by a terminal. The measurement method may include step 111.

Step 111 includes receiving, under a radio resource control (RRC)-connected state, second indication information; where the type of the preferred measurement object is a cell.

In an example, the second indication information is sent to the terminal by the base station through an RRC message in response to the terminal being in the RRC-connected state. The second indication information is configured to determine the preferred measurement object for the mobility measurement to be performed by the terminal before leaving the serving cell. The type of the preferred measurement object includes a cell. The cell may be a plurality of cells contained in a same cell set. The mobility measurement is performed according to the second indication information, in response to receiving the second indication information under the RRC-connected state and determining that a measurement on a predetermined cell cannot be completed within a period from a time when the terminal receives condition handover (CHO) configuration information to a time when the terminal leaves the serving cell.

In an example, it is determined by the base station, in response to the terminal being in the RRC-connected state, whether a measurement on all pre-configured cells can be completed by the terminal before leaving the serving cell. The second indication information is sent to the terminal by the base station in response to determining that the measurement on all the pre-configured cells cannot be completed. The second indication information is configured to determine the preferred measurement object for the mobility measurement to be performed by the terminal before leaving the serving cell. The type of the preferred measurement object includes a cell. The cell may be a plurality of cells contained in a same cell set. The mobility measurement may be performed according to the second indication information, in response to receiving the second indication information under the RRC-connected state and determining that the measurement on the predetermined cell cannot be completed within the period from the time when the terminal receives the condition handover (CHO) configuration information to the time when the terminal leaves the serving cell. In an example, it is determined by the base station, in response to the terminal being in the RRC-connected state, whether a measurement on all pre-configured cells can be completed by the terminal within a period from a time when the terminal receives condition handover (CHO) configuration information to a time when the terminal leaves the serving cell. The second indication information is sent to the terminal by the base station in response to determining that the measurement on all the pre-configured cells cannot be completed. In another example, configuration information (for example, the CHO configuration information) is sent to the terminal by the base station, where the configuration information is configured to indicate a pre-configured cell. It is determined by the base station, in response to the terminal being in the RRC-connected state, whether a measurement on all pre-configured cells can be completed by the terminal within a period from a time when the terminal receives condition handover (CHO) configuration information to a time when the terminal leaves the serving cell. The second indication information is sent to the terminal by the base station in response to determining that the measurement on all the pre-configured cells cannot be completed. The second indication information is configured to determine the preferred measurement object for the mobility measurement to be performed by the terminal before leaving the serving cell. The type of the preferred measurement object includes a cell. The cell may be a plurality of cells contained in a same cell set. The mobility measurement may be performed according to the second indication information, in response to receiving the second indication information under the RRC-connected state and determining that the measurement on the predetermined cell cannot be completed within the period from the time when the terminal receives the condition handover (CHO) configuration information to the time when the terminal leaves the serving cell. It is to be noted that those skilled in the art can understand that the method provided by the example of the disclosure may be performed independently or performed together with some methods in examples of the disclosure or some methods in related art.

As shown in FIG. 12, there is provided a measurement method. The measurement method may be performed by a terminal. The measurement method may include step 121.

Step 121 includes performing the mobility measurement according to the second indication information, in response to receiving the second indication information under the RRC-connected state and determining that the measurement on the predetermined cell cannot be completed within the period from the time when the terminal receives the condition handover (CHO) configuration information to the time when the terminal leaves the serving cell.

In an example, configuration information (for example, the CHO configuration information) is sent to the terminal by the base station, where the configuration information is configured to indicate a pre-configured cell. It is determined by the base station, in response to the terminal being in the RRC-connected state, whether the measurement on all the pre-configured cells can be completed by the terminal within the period from the time when the terminal receives the condition handover (CHO) configuration information to the time when the terminal leaves the serving cell. The second indication information is sent to the terminal by the base station in response to determining that the measurement on all the pre-configured cells cannot be completed. The second indication information is configured to determine the preferred measurement object for the mobility measurement to be performed by the terminal before leaving the serving cell. The type of the preferred measurement object includes a cell. The cell may be a plurality of cells contained in a same cell set. The mobility measurement may be performed according to the second indication information, in response to receiving the second indication information under the RRC-connected state and determining that the measurement on the predetermined cell cannot be completed within the period from the time when the terminal receives the condition handover (CHO) configuration information to the time when the terminal leaves the serving cell.

In an example, time information about when the serving cell stops the service may be sent to the terminal by a network. The terminal, after receiving the time information, may determine a duration (T) from current time to a time when the serving cell stops the service. The terminal may calculate a duration (T′) needed for completing the mobility measurements according to configuration information for the mobility measurements, and in a case that T′ is greater than T, the terminal may determine that the measurement on all the pre-configured cells cannot be completed.

In an example, report information may be sent to the base station by the terminal, where the report information indicates that the measurement on the predetermined carrier cannot be completed by the terminal within the period from the time when the terminal starts performing the neighbor cell-measurement to the time when the serving cell stops providing the service. The base station determines based on the report information that the measurement on the predetermined carrier cannot be completed by the terminal within the period from the time when the terminal starts performing the neighbor cell-measurement to the time when the serving cell stops providing the service.

It is to be noted that those skilled in the art can understand that the method provided by the example of the disclosure may be performed independently or performed together with some methods in examples of the disclosure or some methods in related art.

For better understanding the examples of the disclosure, the technical solution of the disclosure is further described through the following example.

### Example 1

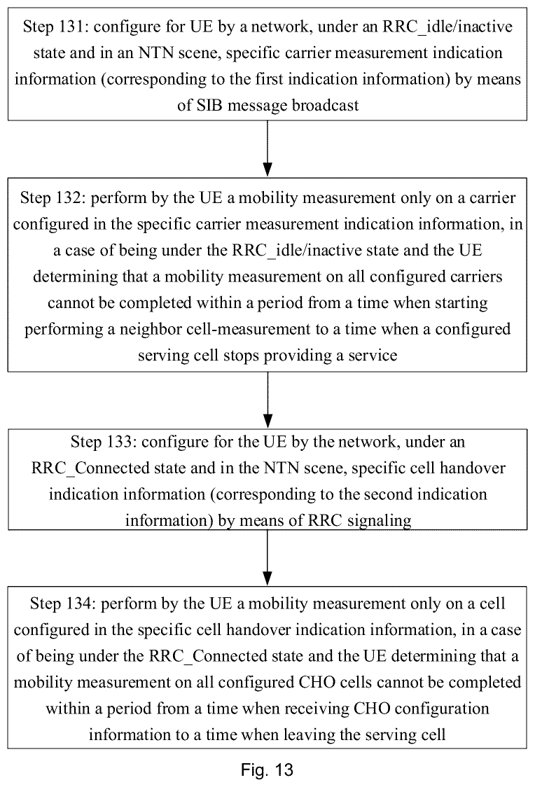

As shown in FIG. 13, there is provided a measurement method. The measurement method may include steps 131, 132, 133 and 134.

Step 131 includes configuring, under an RRC_idle/inactive state and in an NTN scene, specific carrier measurement indication information (corresponding to the first indication information) for UE by a network by means of SIB message broadcast.

Step 132 includes performing by the UE a mobility measurement only on a carrier configured in the specific carrier measurement indication information, in a case that the UE is in the RRC_idle/inactive state and the UE determines that a mobility measurement on all configured carriers cannot be completed within a period from a time when the UE starts performing a neighbor cell-measurement to a time when a configured serving cell stops providing a service.

Step 133 includes configuring for the UE by the network, under an RRC_Connected state and in the NTN scene, specific cell handover indication information (corresponding to the second indication information) by means of RRC signaling.

Step 134 includes performing by the UE a mobility measurement only on a cell configured in the specific cell handover indication information, in a case that the UE is in the RRC_Connected state and the UE determines that a mobility measurement on all configured CHO cells cannot be completed within a period from a time when the UE receives CHO configuration information to a time when the UE leaves the serving cell.

It is to be noted that those skilled in the art can understand that the method provided by the example of the disclosure may be performed independently or performed together with some methods in examples of the disclosure or some methods in related art.

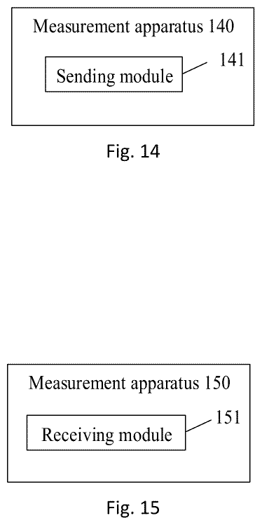

As shown in FIG. 14, an example of the disclosure provides a measurement apparatus 140. The measurement apparatus 140 includes a sending module 141.

The sending module 141 is configured to send indication information to a terminal.

The indication information is configured to determine a preferred measurement object for a mobility measurement to be performed by the terminal before leaving a serving cell. A type of the preferred measurement object includes at least one of a carrier or a cell.

It is to be noted that those skilled in the art can understand that the method provided by the example of the disclosure may be performed independently or performed together with some methods in examples of the disclosure or some methods in related art.

As shown in FIG. 15, an example of the disclosure provides a measurement apparatus 150. The measurement apparatus 150 includes a receiving module 151.

The receiving module 151 is configured to receive indication information.

The indication information is configured to determine a preferred measurement object for a mobility measurement to be performed by a terminal before leaving a serving cell. A type of the preferred measurement object includes at least one of a carrier or a cell.

It is to be noted that those skilled in the art can understand that the method provided by the example of the disclosure may be performed independently or performed together with some methods in examples of the disclosure or some methods in related art.

An example of the disclosure provides a communication device 1800 as shown in FIG. 18, including: a processor 1801; and a memory 1802 configured to store an executable instruction executable by the processor 1801. Where the processor 1801 is configured to implement, when running the executable instruction, the method in any example of the disclosure.

The memory 1802 may include various types of storage media, and the storage medium is a non-transitory computer storage medium and can continue memorizing information stored after the communication device 1800 has a power failure.

The processor 1801 may be connected with the memory 1802 through a bus and the like and configured to read an executable program stored on the memory 1802.

An example of the disclosure further provides a non-transitory computer-readable storage medium, storing a computer-executable program, where the computer-executable program, when executed by a processor, implements the method in any example of the disclosure.

As for the apparatus in the examples, a specific mode of each module for executing an operation has been described in detail in the examples related to the method, which is not described in detail any more.

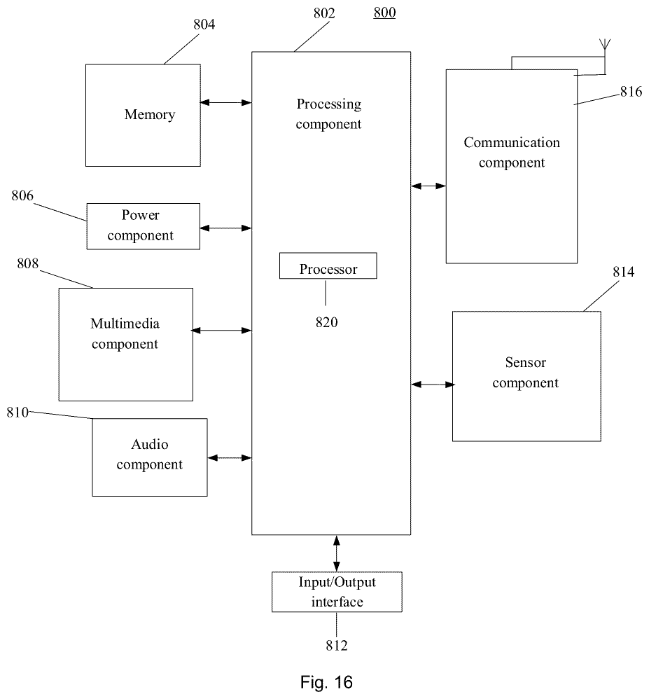

As shown in FIG. 16, an example of the disclosure provides a structure of a terminal. Referring to the terminal 800 shown in FIG. 16, there is provided the terminal 800 which may be a mobile phone, a computer, a digital broadcast terminal, a messaging device, a game console, a tablet device, a medical device, a fitness facility, a personal digital assistant and the like.

Referring to FIG. 16, the terminal 800 may include one or more components as follows: a processing component 802, a memory 804, a power component 806, a multimedia component 808, an audio component 810, an input/output (I/O) interface 812, a sensor component 814 and a communication component 816.

The processing component 802 generally controls whole operation of the terminal 800, such as operations related to display, phone call, data communication, camera operation and recording operation. The processing component 802 may include one or more processors 820 for executing instructions so as to complete all or part of steps of the methods in the disclosure. Besides, the processing component 802 may include one or more modules to facilitate interaction between the processing component 802 and the other components. For example, the processing component 802 may include a multimedia module so as to facilitate interaction between the multimedia component 808 and the processing component 802.

The memory 804 is configured to store various types of data so as to support operations on the terminal 800. Examples of these data include instructions of any application program or method for operation on the terminal 800, contact person data, telephone directory data, messages, pictures, videos and the like. The memory 804 may be implemented by any type of volatile or non-volatile storage device or their combination, such as a static random access memory (SRAM), an electrically erasable programmable read-only memory (EEPROM), an erasable programmable read-only memory (EPROM), a programmable read-only memory (PROM), a read-only memory (ROM), a magnetic memory, a flash memory, a magnetic disk or a compact disc.

The power component 806 provides power for various components of the terminal 800. The power component 806 may include a power management system, one or more power sources, and other components related to power generation, management and distribution for the terminal 800.

The multimedia component 808 includes a screen which provides an output interface between the terminal 800 and a user. In some examples, the screen may include a liquid crystal display (LCD) and a touch panel (TP). If the screen includes the touch panel, the screen may be implemented as a touch screen so as to receive an input signal from the user. The touch panel includes one or more touch sensors so as to sense touching, swiping and gestures on the touch panel. The touch sensor can not only sense a boundary of a touching or swiping action, but also detect duration and pressure related to touching or swiping operation. In some examples, the multimedia component 808 includes at least one of a front camera or a rear camera. When the terminal 800 is in an operation mode, such as a photographing mode or a video mode, at least one of the front camera or the rear camera may receive external multimedia data. Each front camera and each rear camera may be a fixed optical lens system or have a focal length and an optical zoom capability.

The audio component 810 is configured to output and/or input an audio signal. For example, the audio component 810 includes a microphone (MIC). When the terminal 800 is in the operation mode, such as a call mode, a recording mode and a voice recognition mode, the microphone is configured to receive an external audio signal. The received audio signal may be further stored in the memory 804 or sent via the communication component 816. In some examples, the audio component 810 further includes a speaker for outputting the audio signal.

The I/O interface 812 provides an interface between the processing component 802 and a peripheral interface module, and the peripheral interface module may be a keyboard, a click wheel, buttons and the like. These buttons may include but are not limited to a home button, a volume button, a start button and a lock button.

The sensor component 814 includes one or more sensors, configured to provide state evaluation of various aspects for the terminal 800. For example, the sensor component 814 may detect on/off states of the terminal 800 and relative positioning of the components, for example, the components are a display and a keypad of the terminal 800. The sensor component 814 may also detect a position change of the terminal 800 or a component of the terminal 800, whether there is contact between the user and the terminal 800, and a direction or acceleration/deceleration and a temperature change of the terminal 800. The sensor component 814 may include a proximity sensor, configured to detect existence of a nearby object without any physical contact. The sensor component 814 may further include an optical sensor, such as a CMOS or CCD image sensor, for use in an imaging application. In some examples, the sensor component 814 may further include an acceleration sensor, a gyroscope sensor, a magnetic sensor, a pressure sensor or a temperature sensor.

The communication component 816 is configured to facilitate a wired or wireless communication between the terminal 800 and other devices. The terminal 800 may be accessed to a wireless network based on a communication standard, such as Wi-Fi, 2G or 3G, or their combination. In an example, the communication component 816 receives a broadcast signal or related broadcast information from an external broadcast management system via a broadcast channel. In an example, the communication component 816 further includes a near-field communication (NFC) module so as to facilitate a short-range communication. For example, the NFC module may be implemented based on a radio frequency identification (RFID) technology, an infra-red data association (IrDA) technology, an ultra wide band (UWB) technology, a Bluetooth (BT) technology and other technologies.

In an example, the terminal 800 may be implemented by one or more than one application specific integrated circuit (ASIC), digital signal processor (DSP), digital signal processing device (DSPD), programmable logic device (PLD), field-programmable gate array (FPGA), controller, microcontroller, microprocessor or another electronic element for performing the methods in the disclosure.

In an example, a non-transitory computer-readable storage medium including instructions is further provided, such as a memory 804 including the instructions. The instructions may be executed by the processor 820 of the terminal 800 so as to complete the methods in the disclosure. For example, the non-transitory computer-readable storage medium may be an ROM, a random access memory (RAM), a CD-ROM, a magnetic tape, a floppy disk, an optical data storage device and the like.

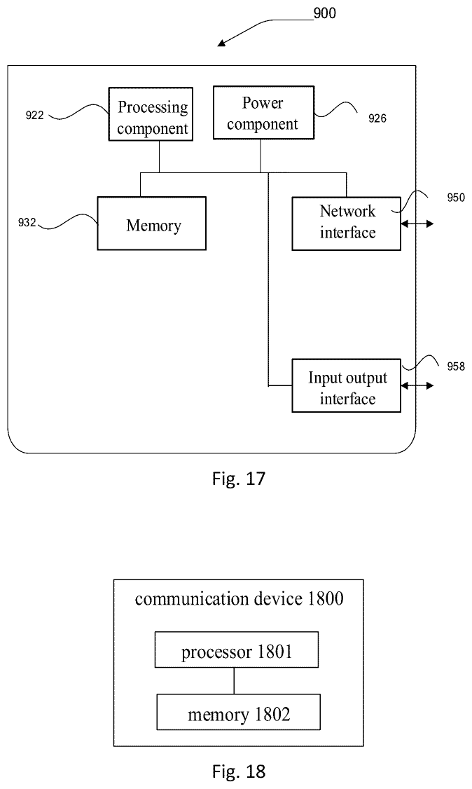

As shown in FIG. 17, an example of the disclosure shows a structure of a base station. For example, the base station 900 may be provided as a network device. Referring to FIG. 17, the base station 900 includes a processing component 922 which further includes one or more processors (not shown) and a memory resource represented by a memory 932, configured to store an instruction capable of being executed by the processing component 922, for example, an application program. The application program stored in the memory 932 may include one or more modules each of which corresponds to a set of instructions. Besides, the processing component 922 is configured to execute an instruction so as to perform any methods performed by the base station in the disclosure.

The base station 900 may further include a power component 926 configured to execute power management of the base station 900, a wired or wireless network interface 950 configured to connect the base station 900 to a network, and an input/output (1/O) interface 958. The base station 900 may operate an operating system stored in the memory 932, for example, Windows Server™, Mac OS X™, Unix™, Linux™, FreeBSD™ or the like.

In the example of the disclosure, the indication information is sent to the terminal; where the indication information is configured to determine the preferred measurement object for the mobility measurement to be performed by the terminal before leaving the serving cell; where the type of the preferred measurement object includes at least one of the carrier or the cell. The indication information may be used to determine the preferred measurement object for the mobility measurement to be performed by the terminal before leaving the serving cell, so the terminal may preferentially perform the mobility measurement on the preferred measurement object before leaving the serving cell. Compared with a manner for any measurement object, the mobility measurement on the preferred measurement object may be completed preferentially, and thus reliability of wireless communications may be improved.

Those skilled in the art will figure out other implementations of the disclosure after considering the specification and practicing the disclosure disclosed. The disclosure intends to cover any variation, use or adaptive change of the disclosure, and these variations, uses or adaptive changes conform to a general principle of the disclosure and include common general knowledge or conventional technical means in the technical field not disclosed by the disclosure. The specification and the examples are regarded as examples, and the true scope and spirit of the disclosure are indicated by the following claims.

It is to be understood that the disclosure is not limited to an accurate structure described in the disclosure and shown in the accompanying drawings, and various modifications and changes can be made without departing from its scope. The scope of the disclosure is limited by the appended claims.

1. A measurement method, performed by a base station, comprising:
sending indication information to a terminal;
wherein the indication information is configured to determine a preferred measurement object for a mobility measurement to be performed by the terminal before leaving a serving cell, and
wherein a type of the preferred measurement object comprises at least one of a carrier or a cell.

2. The method according to claim 1, wherein sending the indication information to the terminal comprises:
sending, under a radio resource control (RRC)-disconnected state, first indication information to the terminal, and
wherein the type of the preferred measurement object is the carrier, and the RRC-disconnected state comprises an RRC-idle state and an RRC-inactive state.

3. The method according to claim 2, wherein sending, under the RRC-disconnected state, the first indication information to the terminal comprises:
sending the first indication information to the terminal, in a case of being under the RRC-disconnected state and determining that a measurement on a predetermined carrier cannot be completed by the terminal within a period from a time when the terminal starts performing a neighbor cell-measurement to a time when the serving cell stops providing a service.

4. The method according to claim 1, wherein sending the indication information to the terminal comprises:
sending, under a radio resource control (RRC)-connected state, second indication information to the terminal, and
wherein the type of the preferred measurement object is the cell.

5. The method according to claim 4, wherein sending, under the RRC-connected state, the second indication information to the terminal comprises:
sending the second indication information to the terminal, in a case of being under the RRC-connected state and determining that a measurement on a predetermined cell cannot be completed by the terminal within a period from a time when the terminal receives condition handover (CHO) configuration information to a time when the terminal leaves the serving cell.

6. A measurement method, performed by a terminal, comprising:
receiving indication information;
wherein the indication information is configured to determine a preferred measurement object for a mobility measurement to be performed by the terminal before leaving a serving cell, and
wherein a type of the preferred measurement object comprises at least one of a carrier or a cell.

7. The method according to claim 6, wherein receiving the indication information comprises:
receiving, under a radio resource control (RRC)-disconnected state, first indication information;
wherein the type of the preferred measurement object is the carrier, and the RRC-disconnected state comprises an RRC-idle state and an RRC-inactive state.

8. The method according to claim 7, further comprising:
performing a measurement according to the first indication information, in response to receiving the first indication information under the RRC-disconnected state and determining that a measurement on a predetermined carrier cannot be completed within a period from a time when starting performing a neighbor cell-measurement to a time when the serving cell stops providing a service.

9. The method according to claim 6, wherein receiving the indication information comprises:
receiving, under a radio resource control (RRC)-connected state, second indication information, and
wherein the type of the preferred measurement object is the cell.

10. The method according to claim 9, further comprising:
performing a measurement according to the second indication information, in response to receiving the second indication information under the RRC-connected state and determining that a measurement on a predetermined cell cannot be completed within a period from a time when receiving condition handover (CHO) configuration information to a time when the terminal leaves the serving cell.

11-12. (canceled)

13. A communication device, comprising:
a memory storing a computer-executable instruction; and
a processor communicatively connected with the memory, and the computer-executable instruction, when executed by the processor, causes the processor to:
send indication information to a terminal,
wherein the indication information is configured to determine a preferred measurement object for a mobility measurement to be performed by the terminal before leaving a serving cell, and
wherein a type of the preferred measurement object comprises at least one of a carrier or a cell.

14. A non-transitory computer-readable storage medium, storing a computer-executable instruction, wherein the computer-executable instruction, when executed by a processor, causes the processor to performs the method according to claim 1.

15. The communication device according to claim 13, wherein the processor is further configured to:
send, under a radio resource control (RRC)-disconnected state, first indication information to the terminal, and
wherein the type of the preferred measurement object is the carrier, and the RRC-disconnected state comprises an RRC-idle state and an RRC-inactive state.

16. The communication device according to claim 15, wherein the processor is further configured to:
send the first indication information to the terminal, in a case of being under the RRC-disconnected state and determining that a measurement on a predetermined carrier cannot be completed by the terminal within a period from a time when the terminal starts performing a neighbor cell-measurement to a time when the serving cell stops providing a service.

17. The communication device according to claim 13, wherein the processor is further configured to:
send, under a radio resource control (RRC)-connected state, second indication information to the terminal, and
wherein the type of the preferred measurement object is the cell.

18. The communication device according to claim 17, wherein the processor is further configured to:
send the second indication information to the terminal, in a case of being under the RRC-connected state and determining that a measurement on a predetermined cell cannot be completed by the terminal within a period from a time when the terminal receives condition handover (CHO) configuration information to a time when the terminal leaves the serving cell.

19. A communication device, comprising:
a memory; and
a processor, communicatively connected with the memory and configured to implement the method according to claim 6 by performing a computer-executable instruction stored on the memory.

20. A non-transitory computer-readable storage medium, storing a computer-executable instruction, wherein the computer-executable instruction, when executed by a processor, causes the processor to perform the method according to claim 6.
